(19) United States
(12) Patent Application Publication
(10) Pub. No.: US 2021/0338523 A1
(43) Pub. Date: Nov. 4, 2021

(54) DOUBLE-HEAD MASSAGE DEVICE

(71) Applicants: Miaoling Zheng, Lufeng (CN); Shenzhen Envision Technology Innovation Co., Ltd., Shenzhen (CN); Shenzhen Shilang Technology Co., Ltd., Shenzhen (CN)

(72) Inventor: Miaoling Zheng, Lufeng (CN)

(73) Assignees: Shenzhen Envision Technology Innovation Co., Ltd.; Shenzhen Shilang Technology Co., Ltd.

(21) Appl. No.: 17/373,806

(22) Filed: Jul. 13, 2021

(30) Foreign Application Priority Data
Sep. 26, 2020 (CN) 202022140165.2

(51) Int. Cl. A61H 23/02; A61H 19/00; A61H 9/00

(52) U.S. Cl. CPC A61H 23/0263; A61H 19/34; A61H 2009/0064; A61H 19/44; A61H 2201/1207; A61H 9/0057

(57) ABSTRACT

The present disclosure provides a double-head massage device, including a silica gel outer shell; a first vibration end and a second vibration end which are respectively disposed at the left and right ends in the silica gel outer shell, the first vibration end and the second vibration end being connected through a connection component, and the second vibration end including a second motor and a rotating shaft disposed on the second motor; an eccentric bearing pedestal fixed with the rotating shaft, a connection rod being arranged on the right side of the eccentric bearing pedestal; and a silica gel pull rod provided with a fixed ring at the bottom, the fixed ring being fixed on the connection rod.

### TECHNICAL FIELD

The present disclosure provides the technical field of massage devices, and specifically relates to a double-head massage device.

### BACKGROUND

With the improvement of people's living standards, people's pursuit of quality of life is also getting higher and higher. In addition to that people's needs for basic necessities are satisfied, people's sensory enjoyment must be satisfied. Therefore, a variety of massage products have emerged. A massage bar is one of the above-mentioned massage products. It stimulates the human body through vibration massage, soothes nerves and relieves stress. Existing massage devices generally can only generate vibrations at both ends, and cannot satisfy various types of massages.

### SUMMARY

In view of this, the present disclosure provides a double-head massage device.

The technical solution used in the present disclosure is as follows:

a double-head massage device, including:

a silica gel outer shell;

a first vibration end and a second vibration end which are respectively disposed at the left and right ends in the silica gel outer shell,

the first vibration end and the second vibration end being connected through a connection component,

the second vibration end including a second motor and a rotating shaft disposed on the second motor;

an eccentric bearing pedestal fixed with the rotating shaft, a connection rod being arranged on the right side of the eccentric bearing pedestal; and

a silica gel pull rod provided with a fixed ring at the bottom, the fixed ring being fixed on the connection rod.

A suction nozzle is provided at a position, located on the silica gel pull rod, on the silica gel outer shell; the interior of the suction nozzle is of a closed structure; and the silica gel pull rod is connected to the bottom of an inner cavity of the suction nozzle.

Further, the second motor is connected with the eccentric bearing pedestal through a rotating shaft; the second motor drives the eccentric bearing pedestal and pulls the silica gel pull rod to pull the suction nozzle to form a negative pressure suction structure in the inner cavity of the suction nozzle.

Further, the lower part of the second motor is provided with a fixed plate, the fixed plate being fixed in a second inner shell assembly;

a battery device arranged on the left side of the second motor; and

a printed circuit board (PCB) arranged at the upper part of the second motor.

The PCB is provided with a button sensor.

The PCB is electrically connected to the battery device and the second motor.

The second inner shell assembly includes a second upper shell and a second lower shell, and the second upper shell is abutted with the second lower shell to form the second inner shell assembly.

Further, the first vibration end includes a first inner shell assembly and a first motor arranged in the first inner shell assembly.

The first inner shell assembly includes a first upper shell and a first lower shell, and the first upper shell is abutted with the first lower shell to form the first inner shell assembly.

Further, the connection component includes a component body, and the left and right ends of the component body are respectively provided with a left connection part and a right connection part;

the left connection part is provided with a left positioning hole, and a first mounting column arranged on the first upper shell passes through the left positioning hole and is fixed with a first mounting hole formed in the first lower shell;

the right connection part is provided with a right positioning hole, and a second mounting column arranged on the second upper shell passes through the right positioning hole and is fixed with a second mounting hole formed in the second lower shell.

A threading hole passing through the component body from right to left, and the first motor is connected with the PCB and the battery device respectively through cables via the threading hole.

One end of the present disclosure vibrates through a first vibration motor, and one end is connected with the eccentric bearing pedestal through a rotating shaft; and the second motor drives the eccentric bearing pedestal and pulls the silica gel pull rod to pull the suction nozzle to form the negative pressure suction structure in the inner cavity of the suction nozzle to suck the skin, which can bring a better massage experience.

### BRIEF DESCRIPTION OF THE DRAWINGS

In order to describe the embodiments of the present disclosure or the technical solutions in the prior art more clearly, drawings required to be used in the embodiments or the illustration of the existing art will be briefly introduced below. Obviously, the drawings in the illustration below are merely some embodiments of the present disclosure. Those ordinarily skilled in the art also can acquire other drawings according to the provided drawings without doing creative work.

FIG. 1 is a schematic structural diagram of the present disclosure;

FIG. 2 and FIG. 3 are exploded diagrams of an internal structure in different directions of FIG. 1 in the present disclosure; and

FIG. 4 is a partially schematic structural diagram of a second vibration end in the present disclosure.

### DESCRIPTION OF THE EMBODIMENTS

The present disclosure will be described in detail below with reference to the accompanying drawings and specific embodiments. The schematic embodiments and illustrations of the present disclosure are used to explain the present disclosure, but are not intended to limit the present disclosure.

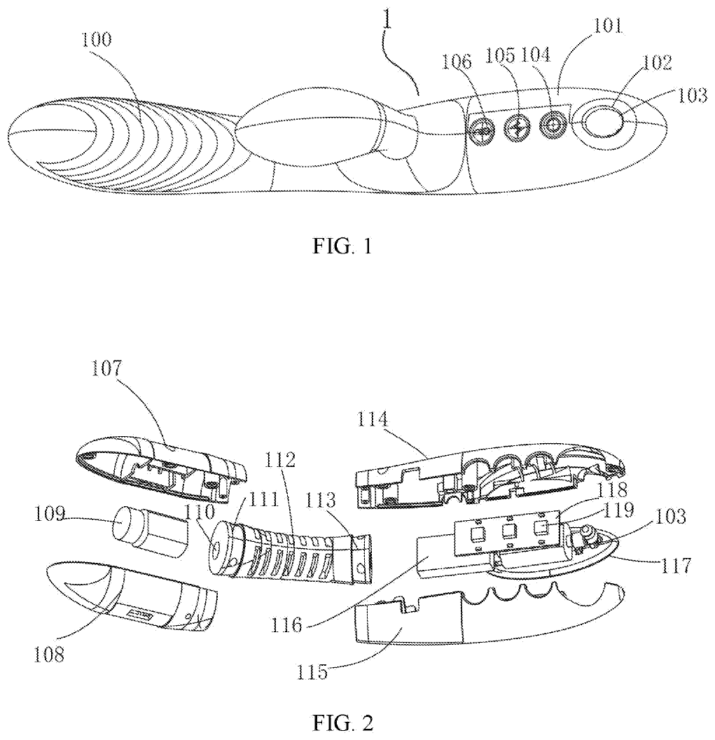

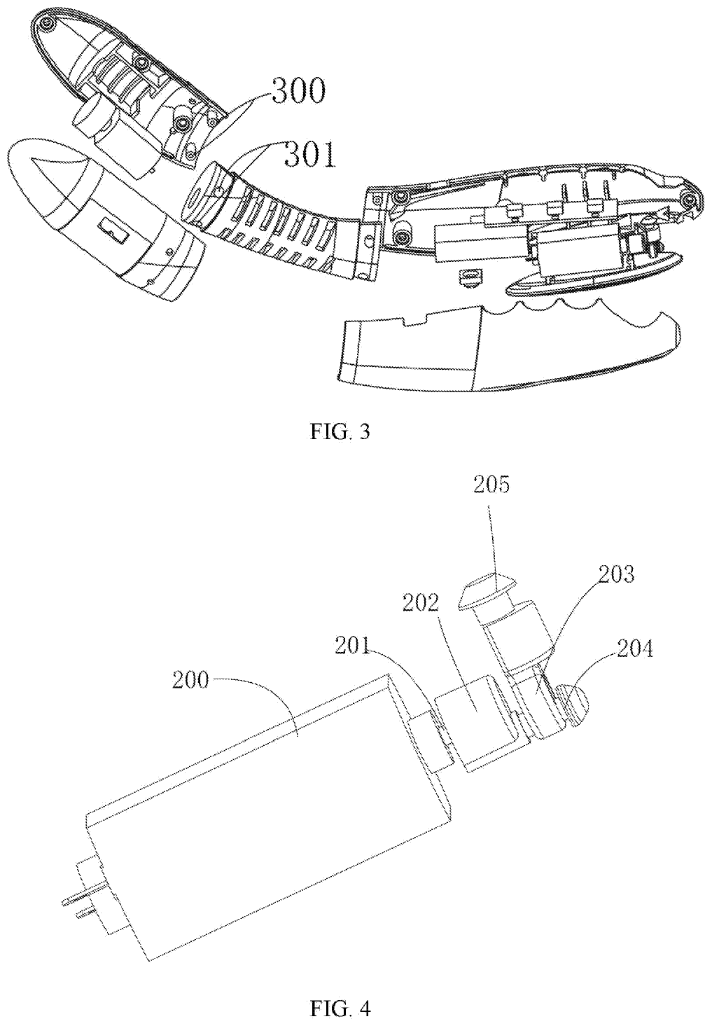

Referring to FIG. 1 to FIG. 2, the present disclosure provides a double-head massage device, including

a silica gel outer shell 1;

a first vibration end 100 and a second vibration end 101 which are respectively disposed at the left and right ends in the silica gel outer shell 1,

the first vibration end 100 and the second vibration end 101 being connected through a connection component,

the second vibration end 101 including a second motor 200 and a rotating shaft 201 disposed on the second motor 200;

an eccentric bearing pedestal 202 fixed with the rotating shaft 201, a connection rod 204 being arranged on the right side of the eccentric bearing pedestal 202; and

a silica gel pull rod provided with a fixed ring 203 at the bottom, the fixed ring 203 being fixed on the connection rod 204.

A suction nozzle 102 is provided at a position, located on the silica gel pull rod, on the silica gel outer shell 1; the interior of the suction nozzle 102 is of a closed structure 103; and the silica gel pull rod is connected to the bottom of an inner cavity of the suction nozzle through a connector 205. The second motor 200 is connected with the eccentric bearing pedestal 202 through a rotating shaft 201; the second motor 200 drives the eccentric bearing pedestal 202 and pulls the silica gel pull rod to pull the suction nozzle 102 to form a negative pressure suction structure in the inner cavity of the suction nozzle.

According to the above, the lower part of the second motor 200 is provided with a fixed plate 117, the fixed plate 117 being fixed in a second inner shell assembly;

a battery device 116 arranged on the left side of the second motor 117; and

a printed circuit board (PCB) 118 arranged at the upper part of the second motor 117.

The PCB 118 is provided with a plurality of button sensors 119.

The PCB 118 is electrically connected to the battery device 116 and the second motor 117.

The second inner shell assembly includes a second upper shell 114 and a second lower shell 115, and the second upper shell 114 is abutted with the second lower shell 115 to form the second inner shell assembly.

Further, the first vibration end 100 includes a first inner shell assembly and a first motor 109 arranged in the first inner shell assembly.

The first inner shell assembly includes a first upper shell 107 and a first lower shell 108, and the first upper shell 107 is abutted with the first lower shell 108 to form the first inner shell assembly.

The connection component includes a component body 112, and the left and right ends of the component body 112 are respectively provided with a left connection part 111 and a right connection part 113;

the left connection part 111 is provided with a left positioning hole 301, and a second mounting column 300 arranged on the first upper shell 107 is fixed with a first mounting hole formed in the lower shell;

the right connection part is provided with a right positioning hole, and a second mounting column arranged on the second upper shell passes through the right positioning hole and is fixed with a second mounting hole formed in the second lower shell.

A threading hole 110 passing through the component body from right to left, and the first motor is connected with the PCB and the battery device respectively through cables via the threading hole.

During use, referring to FIG. 1, a first button, a second button, and a third button are arranged on the silica gel outer shell from left to right. In a vibration mode, a long press on the second button initiates the first motor to vibrate at a strong level in a first continuous mode; then a single click is applied to change the mode (10 modes in total); and a long press is applied to power off the motor. A single click on the third button realizes vibration intensity adjustment (3 levels), and a long press on any one of the buttons can shut off the vibration. A long press powers off the motor. A long press on the first button to start a heating function, and a long press stops the heating function.

A long press on the second button initiates the second motor to vibrate at a strong level of the first continuous mode; a single click changes the mode (10 modes including 3 intensity modes in total); and a long press powers off the motor. A long press on the first button starts the heating function, and a long press stops the heating function; and a long press on the third button enters suction nozzle intensity adjustment (5 levels in total), and a long press shuts off the adjustment. One end of the present disclosure vibrates through a first vibration motor, and one end is connected with the eccentric bearing pedestal through a rotating shaft; and the second motor drives the eccentric bearing pedestal and pulls the silica gel pull rod to pull the suction nozzle to form the negative pressure suction structure in the inner cavity of the suction nozzle to suck the skin, which can bring a better massage experience.

The technical solutions disclosed in the embodiments of the present disclosure are described in detail above, and specific embodiments are used herein to explain the principles and implementation modes of the embodiments of the present disclosure. The descriptions of the above embodiments are only applicable to help the understanding of the principle of the embodiments of the present disclosure. Moreover, for those of ordinary skill in the art, according to the embodiments of the present disclosure, there will be changes in the specific implementation modes and the scope of application. In summary, the content of the present specification should not be construed as a restriction to the present disclosure.

What is claimed is:

1. A double-head massage device, comprising:
a silica gel outer shell;
a first vibration end and a second vibration end which are respectively disposed at the left and right ends in the silica gel outer shell,
the first vibration end and the second vibration end being connected through a connection component,
the second vibration end comprising a second motor and a rotating shaft disposed on the second motor;
an eccentric bearing pedestal fixed with the rotating shaft, a connection rod being arranged on the right side of the eccentric bearing pedestal; and
a silica gel pull rod provided with a fixed ring at the bottom, the fixed ring being fixed on the connection rod, wherein
a suction nozzle is provided at a position, located on the silica gel pull rod, on the silica gel outer shell; the interior of the suction nozzle is of a closed structure; and the silica gel pull rod is connected to the bottom of an inner cavity of the suction nozzle.

2. The double-head massage device according to claim 1, wherein the second motor is connected with the eccentric bearing pedestal through a rotating shaft; the second motor drives the eccentric bearing pedestal and pulls the silica gel pull rod to pull the suction nozzle to form a negative pressure suction structure in the inner cavity of the suction nozzle.

3. The double-head massage device according to claim 1, wherein the lower part of the second motor is provided with a fixed plate, the fixed plate being fixed in a second inner shell assembly;
a battery device arranged on the left side of the second motor; and
a printed circuit board (PCB) arranged at the upper part of the second motor;
the PCB is provided with a button sensor;
wherein the PCB is electrically connected to the battery device and the second motor;
the second inner shell assembly comprises a second upper shell and a second lower shell, and the second upper shell is abutted with the second lower shell to form the second inner shell assembly.

4. The double-head massage device according to claim 1, wherein the first vibration end comprises a first inner shell assembly and a first motor arranged in the first inner shell assembly;
the first inner shell assembly comprises a first upper shell and a first lower shell, and the first upper shell is abutted with the first lower shell to form the first inner shell assembly.

5. The double-head massage device according to claim 1, wherein the connection component comprises a component body; the left and right ends of the component body are respectively provided with a left connection part and a right connection part;
the left connection part is provided with a left positioning hole, and a first mounting column arranged on the first upper shell passes through the left positioning hole and is fixed with a first mounting hole formed in the first lower shell;
the right connection part is provided with a right positioning hole, and a second mounting column arranged on the second upper shell passes through the right positioning hole and is fixed with a second mounting hole formed in the second lower shell;
a threading hole passing through the component body from right to left, and the first motor is connected with the PCB and the battery device respectively through cables via the threading hole.
